(19) United States
(12) Patent Application Publication
(10) Pub. No.: US 2026/0360042 A1
(43) Pub. Date: Nov. 12, 2026

(54) CLIENT-BASED IMAGE VIEW MANIPULATION

(71) Applicant: Airbnb, Inc., San Francisco, CA (US)

(72) Inventors: Kieraj Singh Mumick, San Francisco, CA (US); David Sutton, Truckee, CA (US)

(21) Appl. No.: 19/656,579

(22) Filed: Apr. 23, 2026

Related U.S. Application Data
(60) Provisional application No. 63/804,438, filed on May 12, 2025.

(51) Int. Cl. G06T 11/60

(52) U.S. Cl. CPC G06T 11/60

(57) ABSTRACT

An embodiment includes generating a grid view of one or more images in a set of images, the grid view generated by generating a grid mask corresponding to each of the one or more images and rendering each image into its corresponding grid mask. An embodiment includes generating a single-image view of an image in the set of images, the single-image view generated by generating a single-image mask corresponding to the image and rendering the image into the single-image mask. An embodiment includes generating a column gallery view of one or more images in the set of images, the column gallery view generated by a gallery mask corresponding to each of the one or more images and rendering each image into its corresponding gallery mask.

### CROSS-REFERENCE OF RELATED APPLICATION

This application claims the benefit of U.S. Provisional Application No. 63/804438, filed on May. 12, 2025, which is incorporated herein in its entirety.

### TECHNICAL FIELD

The present disclosure generally relates to image display, and more particularly to client-based image view manipulation.

### BACKGROUND

A social media platform refers to a website or software application that allows users to share content with each other. Users of a social media platform typically generate content to share, such as still images, audio, or video (often including audio), on a mobile device, because mobile devices typically include a suitable camera, a microphone, a connection to a communications network such as the internet, and can execute a software application that uploads content to the social media platform.

An asset management platform facilitates management of fixed-location assets such as properties, typically providing options for advertising an asset’s availability, searching for an asset based on one or more criteria, generating or viewing an asset description, reserving an asset for use, paying for an asset’s use, and managing an existing reservation. One non-limiting example of an asset management platform is a property reservation platform managing listing options for guests to reserve and pay for stays at one or more properties, such as hotel rooms, apartments, or houses. A property reservation platform typically includes an ability to search for a property based on one or more criteria, generate or view a property description (optionally including a map, image of the property, video, or reviews from previous guests), reserve and pay for a stay at a property, and manage an existing reservation as a guest or host. The platform is typically implemented on a server and users access the platform via a website or application executing on a client device.

### SUMMARY

Some embodiments of the present disclosure provide a computer-implemented method for client-based image view manipulation. The method includes generating a grid view of one or more images in a set of images, the grid view arranging each of the one or more images with the same displayed shape and dimensions, the grid view generated by generating a grid mask corresponding to each of the one or more images and rendering each image into its corresponding grid mask; generating a single-image view of an image in the set of images, the single-image view displaying the image in an original shape and aspect ratio of the image, the single-image view generated by generating a single-image mask corresponding to the image and rendering the image into the single-image mask; and generating a column gallery view of one or more images in the set of images, the column gallery view displaying each of the one or more images in one or more columns with the same displayed width and an original aspect ratio of each of the one or more images, the column gallery view generated by a gallery mask corresponding to each of the one or more images and rendering each image into its corresponding gallery mask.

Some embodiments of the present disclosure provide a non-transitory computer-readable medium storing a program for client-based image view manipulation. The program, when executed by a computer, configures the computer to generate a grid view of one or more images in a set of images, the grid view arranging each of the one or more images with the same displayed shape and dimensions, the grid view generated by generating a grid mask corresponding to each of the one or more images and rendering each image into its corresponding grid mask; generate a single-image view of an image in the set of images, the single-image view displaying the image in an original shape and aspect ratio of the image, the single-image view generated by generating a single-image mask corresponding to the image and rendering the image into the single-image mask; and generate a column gallery view of one or more images in the set of images, the column gallery view displaying each of the one or more images in one or more columns with the same displayed width and an original aspect ratio of each of the one or more images, the column gallery view generated by a gallery mask corresponding to each of the one or more images and rendering each image into its corresponding gallery mask.

Some embodiments of the present disclosure provide a system for client-based image view manipulation. The system comprises a processor and a non-transitory computer readable medium storing a set of instructions, which when executed by the processor, configure the processor to generate a grid view of one or more images in a set of images, the grid view arranging each of the one or more images with the same displayed shape and dimensions, the grid view generated by generating a grid mask corresponding to each of the one or more images and rendering each image into its corresponding grid mask; generate a single-image view of an image in the set of images, the single-image view displaying the image in an original shape and aspect ratio of the image, the single-image view generated by generating a single-image mask corresponding to the image and rendering the image into the single-image mask; and generate a column gallery view of one or more images in the set of images, the column gallery view displaying each of the one or more images in one or more columns with the same displayed width and an original aspect ratio of each of the one or more images, the column gallery view generated by a gallery mask corresponding to each of the one or more images and rendering each image into its corresponding gallery mask.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments.

FIG. 1 illustrates a network architecture used to implement client-based image view manipulation, according to some embodiments.

FIG. 2 is a block diagram illustrating details of a system for client-based image view manipulation, according to some embodiments.

FIG. 3 depicts a block diagram of an example configuration for client-based image view manipulation, in accordance with an illustrative embodiment.

FIG. 4 depicts an example of client-based image view manipulation, in accordance with an illustrative embodiment.

FIG. 5 depicts another example of client-based image view manipulation, in accordance with an illustrative embodiment.

FIG. 6 depicts another example of client-based image view manipulation, in accordance with an illustrative embodiment.

FIG. 7 depicts another example of client-based image view manipulation, in accordance with an illustrative embodiment.

FIG. 8 depicts a flowchart of an example process for client-based image view manipulation. in accordance with an illustrative embodiment.

In one or more implementations, not all of the depicted components in each figure may be required, and one or more implementations may include additional components not shown in a figure. Variations in the arrangement and type of the components may be made without departing from the scope of the subject disclosure. Additional components, different components, or fewer components may be utilized within the scope of the subject disclosure.

### DETAILED DESCRIPTION

In the following detailed description, numerous specific details are set forth to provide a full understanding of the present disclosure. It will be apparent, however, to one ordinarily skilled in the art, that the embodiments of the present disclosure may be practiced without some of these specific details. In other instances, well-known structures and techniques have not been shown in detail so as not to obscure the disclosure.

One typical use case of both a social media platform and a property management platform is to display a set of images. For example, a post on a social media platform might include a set of images of people at a party, or of a user’s pet, and a post on a property management platform might include a set of images of a property available for booking. A user accesses a set of images, for example, via an application (e.g., a dedicated application or a web browser) executing on a client system or device. A user is typically offered options to view the set of images, or a subset of the set of images, in different views and arrangements. Implementing these different views and arrangements typically requires downloading multiple versions of a single image from a server (e.g., with different dimensions to accommodate different views, a magnified version to accommodate zooming in, and the like), consuming additional network bandwidth, adding to response time until a new view is ready for a user, and burdening a server with storing and manipulating multiple versions of the same image to support different viewing use cases. In addition, images in a set of images may have different resolutions, dimensions, and other characteristics, and accommodating these disparate characteristics in an aesthetically pleasing manner can be difficult.

Thus, there is a need for client-based image view manipulation, without the need for multiple versions of the same image and accommodating disparate image characteristics automatically. Embodiments of the present disclosure address the above identified problems by implementing client-based image view manipulation.

An embodiment receives a set of images for display to a user. As used herein, a set of images includes at least one image. For example, the set of images might be part of a listing of a property on a property reservation platform or be part of a posting on a social media platform.

An embodiment generates a grid view of one or more images in the set of images. A grid view arranges displayed images in a grid, with all the displayed images having the same displayed shape (e.g., polygonal or circular) and dimensions or aspect ratio (for rectangular images). One non-limiting example of a grid view is a 2x2 grid of rectangular images sized to fit the full width of an application window in which the images are displayed. To generate a grid view of one or more images in the set of images, an embodiment generates a mask for each image and renders an image into its corresponding mask. As a result, portions of the image outside the mask area are cropped and not visible, without altering the original image or requiring an additional image from a server. An embodiment generates an image’s mask based on the dimensions of an application window in which the images are displayed. For example, an embodiment might select mask dimensions sized so that the entire grid view fills the full width of an application window. One embodiment transitions from another view to the grid view using one or more transitional views, in which masking used to generate the previous view is adjusted through one or more transitional states until a final state displaying the desired grid view.

An embodiment generates a single-image view of an image in the set of images. A single-image view displays one image in the image’s original shape and aspect ratio. One non-limiting example of a single-image view is a rectangular image sized to fit the full width of an application window in which the image is displayed. To generate a single-image view of an image in the set of images, an embodiment generates a mask for the image and renders the image into its corresponding mask. The generated mask masks off, or removes, other displayed elements from view, leaving only the desired image. As a result, only the selected image within the mask area is visible, without altering the original image or requiring an additional image from a server. An embodiment generates an image’s mask based on the dimensions of an application window in which the images are displayed. For example, an embodiment might select mask dimensions sized so that the selected image fills the full width of an application window. One embodiment transitions from another view to a single-image view using one or more transitional views, in which masking used to generate the previous view is adjusted through one or more transitional states until a final state displaying the desired single-image view.

An embodiment transitions from a single-image view of one image to a single-image view of the next or previous image in the set, in response to the user’s selection of the next or previous image via a user interface. In one example user interface, a user uses a pointing device or finger to move a displayed image left (to indicate selection of the previous image) or right (to indicate selection of the next image). One embodiment transitions from one single-image view to another single-image view by adjusting the masking of each image through one or more transitional states, in which progressively less of the original image and progressively more of the new image is displayed. Parallax scrolling is a presently available computer graphics technique in which a background portion of an image moves past a user’s view more slowly than a foreground portion of an image, creating an illusion of depth in a two-dimensional scene. One embodiment implements parallax scrolling by zooming into the original image, then moving the masks so that as the user scrolls in one direction the original image is moved a smaller amount in the opposite direction, creating an effect of looking through panes of a window.

An embodiment generates a gallery view of all images, or a subset of all images, in the set of images. A gallery view displays images in rows or columns. If the gallery view displays images in one or more rows, each image in a row has the same height but can have a different width to preserve the image’s original aspect ratio. If the gallery view displays images in one or more columns, each image in a column has the same width but can have a different height to preserve the image’s original aspect ratio. One non-limiting example of a gallery view is a two-column image arrangement sized to fit the full width of an application window in which the images are displayed. To generate a gallery view of images, an embodiment generates a mask for each image and renders an image into its corresponding mask. As a result, portions of the image outside the mask area are cropped and not visible, without altering the original image or requiring an additional image from a server. The generated mask masks off, or removes, other displayed elements from view, leaving only the desired images. An embodiment generates an image’s mask based on the dimensions of an application window in which the images are displayed. For example, an embodiment might select mask dimensions sized so that, for a two-column view, the two columns of images fill the full width of an application window. One embodiment selects a specific gallery view based on the dimensions of an application window in which the images are displayed. For example, if the application is wider than it is tall, the embodiment might select a gallery view using rows, and if the application is taller than it is wide, the embodiment might select a gallery view using columns. One embodiment transitions from another view to a gallery view using one or more transitional views, in which masking used to generate the previous view is adjusted through one or more transitional states until a final state displaying the desired gallery view.

When generating masking for a gallery view using columns, images in each column are likely to have different heights (due to differing aspect ratios in the original images). Thus, when generating columns of masks for images one embodiment adds the next image mask to the column that is currently shortest. However, especially in a two-column view, if the right column is slightly longer than the left column, a user who reads a left-to-right written language such as English or French is likely to find the display unbalanced and appear to be leaning right. Similarly, if the left column is slightly longer than the right column, a user who reads a right-to-left written language such as Hebrew or Arabic is likely to find the display unbalanced and appear to be leaning left. Thus, when generating columns of masks for images, another embodiment adds the next image mask to the column that is currently shortest, unless the sum of aspect ratios for the image masks already placed in one column is within a threshold amount or percentage difference from the sum of aspect ratios for the image masks already placed in the other column. If the sum of aspect ratios is within the threshold amount or percentage, the embodiment places the image mask in the left column if the user is using a left-to-right written language and places the image mask in the right column if the user is using a right-to-left written language. For example, a square image has an aspect ratio of one, and a rectangular image with a 16/9 aspect ratio (i.e., wider than it is high) has an aspect ratio of 16 divided by 9, or 1.8. One non-limiting example of a threshold difference is four percent. Other techniques for column adjustment and other thresholds are also possible and contemplated within the scope of the illustrative embodiments.

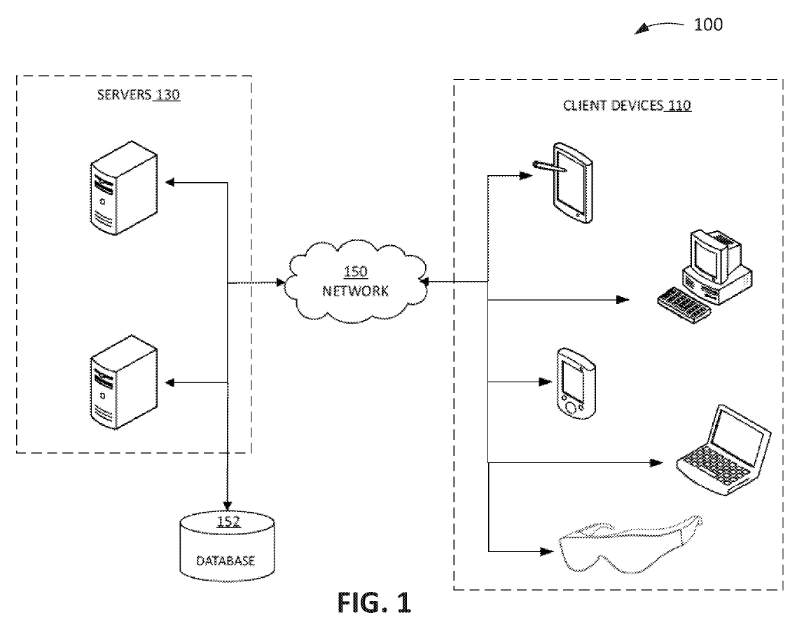

FIG. 1 illustrates a network architecture 100 used to implement client-based image view manipulation, according to some embodiments. The network architecture 100 may include one or more client devices 110 and servers 130, communicatively coupled via a network 150 with each other and to at least one database 152. Database 152 may store data and files associated with the servers 130 and/or the client devices 110. In some embodiments, client devices 110 collect data, video, images, and the like, for upload to the servers 130 to store in the database 152.

The network 150 may include a wired network (e.g., fiber optics, copper wire, telephone lines, and the like) and/or a wireless network (e.g., a satellite network, a cellular network, a radiofrequency (RF) network, Wi-Fi, Bluetooth, and the like). The network 150 may further include one or more of a local area network (LAN), a wide area network (WAN), the Internet, and the like. Further, the network 150 may include, but is not limited to, any one or more of the following network topologies, including a bus network, a star network, a ring network, a mesh network, and the like.

Client devices 110 may include, but are not limited to, laptop computers, desktop computers, and mobile devices such as smart phones, tablets, televisions, wearable devices, head-mounted devices, display devices, and the like.

In some embodiments, the servers 130 may be a cloud server or a group of cloud servers. In other embodiments, some or all of the servers 130 may not be cloud-based servers (i.e., may be implemented outside of a cloud computing environment, including but not limited to an on-premises environment), or may be partially cloud-based. Some or all of the servers 130 may be part of a cloud computing server, including but not limited to rack-mounted computing devices and panels. Such panels may include but are not limited to processing boards, switchboards, routers, and other network devices. In some embodiments, the servers 130 may include the client devices 110 as well, such that they are peers.

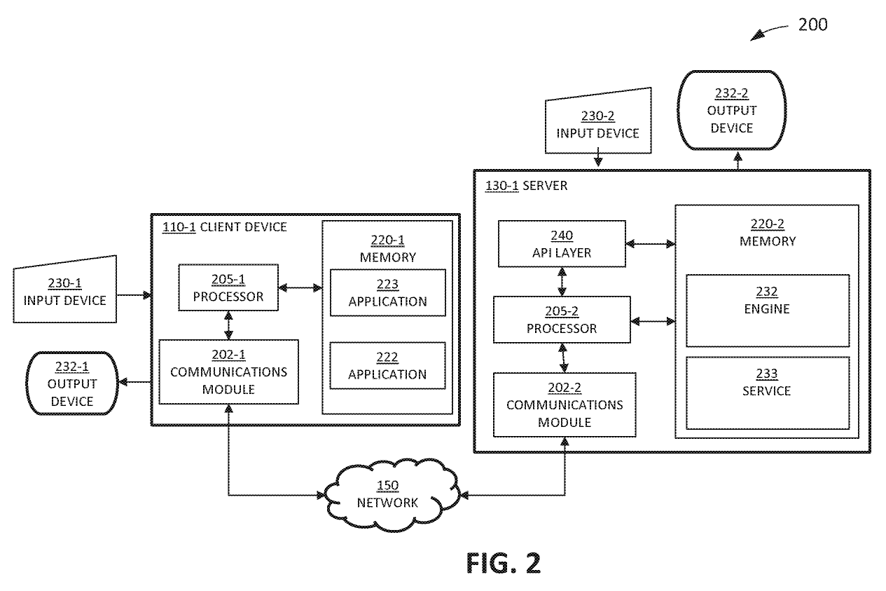

FIG. 2 is a block diagram illustrating details of a system 200 for client-based image view manipulation, according to some embodiments. Specifically, the example of FIG. 2 illustrates an exemplary client device 110-1 (of the client devices 110) and an exemplary server 130-1 (of the servers 130) in the network architecture 100 of FIG. 1.

Client device 110-1 and server 130-1 are communicatively coupled over network 150 via respective communications modules 202-1 and 202-2 (hereinafter, collectively referred to as “communications modules 202”). Communications modules 202 are configured to interface with network 150 to send and receive information, such as requests, data, messages, commands, and the like, to other devices on the network 150. Communications modules 202 can be, for example, modems or Ethernet cards, and/or may include radio hardware and software for wireless communications (e.g., via electromagnetic radiation, such as radiofrequency (RF), near field communications (NFC), Wi-Fi, and Bluetooth radio technology).

The client device 110-1 and server 130-1 also include a processor 205-1, 205-2 and memory 220-1, 220-2, respectively. Processors 205-1 and 205-2, and memories 220-1 and 220-2 will be collectively referred to, hereinafter, as “processors 205,” and “memories 220.” Processors 205 may be configured to execute instructions stored in memories 220, to cause client device 110-1 and/or server 130-1 to perform methods and operations consistent with embodiments of the present disclosure.

The client device 110-1 and the server 130-1 are each coupled to at least one input device 230-1 and input device 230-2, respectively (hereinafter, collectively referred to as “input devices 230”). The input devices 230 can include a mouse, a controller, a keyboard, a pointer, a stylus, a touchscreen, a microphone, voice recognition software, a joystick, a virtual joystick, a touch-screen display, and the like. In some embodiments, the input devices 230 may include cameras, microphones, sensors, and the like. In some embodiments, the sensors may include touch sensors, acoustic sensors, inertial motion units and the like.

In further examples, input devices 320 may include biometric components, motion components, environmental components, or position components, among a wide array of other components. For example, the biometric components include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies include electroencephalography (EEG) based BMIs, which record electrical activity in the brain using electrodes placed on the scalp; invasive BMIs, which use electrodes that are surgically implanted into the brain; and optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The client device 110-1 and the server 130-1 are also coupled to at least one output device 232-1 and output device 232-2, respectively (hereinafter, collectively referred to as “output devices 232”). The output devices 232 may include a screen, a display (e.g., a same touchscreen display used as an input device), a speaker, an alarm, and the like. A user may interact with client device 110-1 and/or server 130-1 via the input devices 230 and the output devices 232.

Memory 220-1 may further include an application 222, configured to execute on client device 110-1 and couple with input device 230-1 and output device 232-1, and implement client-based image view manipulation. The application 222 may be downloaded by the user from server 130-1, and/or may be hosted by server 130-1. The application 222 may include specific instructions which, when executed by processor 205-1, cause operations to be performed consistent with embodiments of the present disclosure. In some embodiments, the application 222 runs on an operating system (OS) installed in client device 110-1. In some embodiments, application 222 may run within a web browser. In some embodiments, the processor 205-1 is configured to control a graphical user interface (GUI) (e.g., spanning at least a portion of input devices 230 and output devices 232) for the user of client device 110-1 to access the server 130-1.

In some embodiments, memory 220-2 includes an application engine 232. The application engine 232 may be configured to perform methods and operations consistent with embodiments of the present disclosure. The application engine 232 may share or provide features and resources with the client device 110-1, including data, libraries, and/or applications retrieved with application engine 232 (e.g., application 222). The user may access the application engine 232 through the application 222. The application 222 may be installed in client device 110-1 by the application engine 232 and/or may execute scripts, routines, programs, applications, and the like provided by the application engine 232.

Memory 220-1 may further include an application 223, configured to execute in client device 110-1. The application 223 may communicate with service 233 in memory 220-2 to provide client-based image view manipulation. The application 223 may communicate with service 233 through API layer 240, for example.

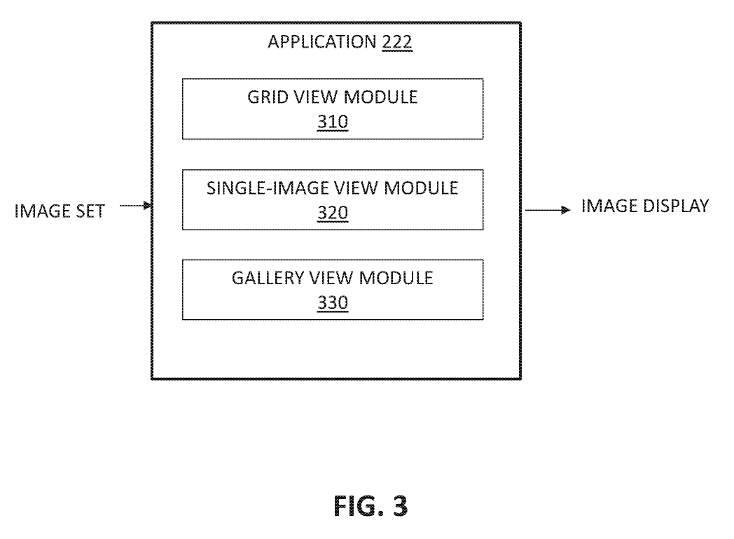

FIG. 3 depicts a block diagram of an example configuration for client-based image view manipulation, in accordance with an illustrative embodiment. Application 222 is the same as application 222 in FIG. 2.

Application 222 receives a set of images for display to a user. As used herein, a set of images includes at least one image. For example, the set of images might be part of a listing of a property on a property reservation platform or be part of a posting on a social media platform.

Grid view module 310 generates a grid view of one or more images in the set of images. A grid view arranges displayed images in a grid, with all the displayed images having the same displayed shape (e.g., polygonal or circular) and dimensions or aspect ratio (for rectangular images). One non-limiting example of a grid view is a 2x2 grid of rectangular images sized to fit the full width of an application window in which the images are displayed. To generate a grid view of one or more images in the set of images, module 310 generates a mask for each image and renders an image into its corresponding mask. As a result, portions of the image outside the mask area are cropped and not visible, without altering the original image or requiring an additional image from a server. Module 310 generates an image’s mask based on the dimensions of an application window in which the images are displayed. For example, module 310 might select mask dimensions sized so that the entire grid view fills the full width of an application window. One implementation of module 310 transitions from another view to the grid view using one or more transitional views, in which masking used to generate the previous view is adjusted through one or more transitional states until a final state displaying the desired grid view.

Single-image view module 320 generates a single-image view of an image in the set of images. A single-image view displays one image in the image’s original shape and aspect ratio. One non-limiting example of a single-image view is a rectangular image sized to fit the full width of an application window in which the image is displayed. To generate a single-image view of an image in the set of images, module 320 generates a mask for the image and renders the image into its corresponding mask. The generated mask masks off, or removes, other displayed elements from view, leaving only the desired image. As a result, only the selected image within the mask area is visible, without altering the original image or requiring an additional image from a server. Module 320 generates an image’s mask based on the dimensions of an application window in which the images are displayed. For example, module 320 might select mask dimensions sized so that the selected image fills the full width of an application window. One implementation of module 320 transitions from another view to a single-image view using one or more transitional views, in which masking used to generate the previous view is adjusted through one or more transitional states until a final state displaying the desired single-image view.

Module 320 transitions from a single-image view of one image to a single-image view of the next or previous image in the set, in response to the user’s selection of the next or previous image via a user interface. In one example user interface, a user uses a pointing device or finger to move a displayed image left (to indicate selection of the previous image) or right (to indicate selection of the next image). One implementation of module 320 transitions from one single-image view to another single-image view by adjusting the masking of each image through one or more transitional states, in which progressively less of the original image and progressively more of the new image is displayed. Parallax scrolling is a presently available computer graphics technique in which a background portion of an image moves past a user’s view more slowly than a foreground portion of an image, creating an illusion of depth in a two-dimensional scene. One implementation of module 320 implements parallax scrolling by zooming into the original image, then moving the masks so that as the user scrolls in one direction the original image is moved a smaller amount in the opposite direction, creating an effect of looking through panes of a window.

Gallery view module 330 generates a gallery view of all images, or a subset of all images, in the set of images. A gallery view displays images in rows or columns. If the gallery view displays images in one or more rows, each image in a row has the same height but can have a different width to preserve the image’s original aspect ratio. If the gallery view displays images in one or more columns, each image in a column has the same width but can have a different height to preserve the image’s original aspect ratio. One non-limiting example of a gallery view is a two-column image arrangement sized to fit the full width of an application window in which the images are displayed. To generate a gallery view of images, module 330 generates a mask for each image and renders an image into its corresponding mask. As a result, portions of the image outside the mask area are cropped and not visible, without altering the original image or requiring an additional image from a server. The generated mask masks off, or removes, other displayed elements from view, leaving only the desired images. Module 330 generates an image’s mask based on the dimensions of an application window in which the images are displayed. For example, module 330 might select mask dimensions sized so that, for a two-column view, the two columns of images fill the full width of an application window. One implementation of module 330 selects a specific gallery view based on the dimensions of an application window in which the images are displayed. For example, if the application is wider than it is tall, module 330 might select a gallery view using rows, and if the application is taller than it is wide, module 330 might select a gallery view using columns. One implementation of module 330 transitions from another view to a gallery view using one or more transitional views, in which masking used to generate the previous view is adjusted through one or more transitional states until a final state displaying the desired gallery view.

When generating masking for a gallery view using columns, images in each column are likely to have different heights (due to differing aspect ratios in the original images). Thus, when generating columns of masks for images, one implementation of module 330 adds the next image mask to the column that is currently shortest. However, especially in a two-column view, if the right column is slightly longer than the left column, a user who reads a left-to-right written language such as English or French is likely to find the display unbalanced and appear to be leaning right. Similarly, if the left column is slightly longer than the right column, a user who reads a right-to-left written language such as Hebrew or Arabic is likely to find the display unbalanced and appear to be leaning left. Thus, when generating columns of masks for images, another implementation of module 330 adds the next image mask to the column that is currently shortest, unless the sum of aspect ratios for the image masks already placed in one column is within a threshold amount or percentage difference from the sum of aspect ratios for the image masks already placed in the other column. If the sum of aspect ratios is within the threshold amount or percentage, the embodiment places the image mask in the left column if the user is using a left-to-right written language and places the image mask in the right column if the user is using a right-to-left written language. For example, a square image has an aspect ratio of one, and a rectangular image with a 16/9 aspect ratio (i.e., wider than it is high) has an aspect ratio of 16 divided by 9, or 1.8. One non-limiting example of a threshold difference is four percent. Other techniques for column adjustment and other thresholds are also possible.

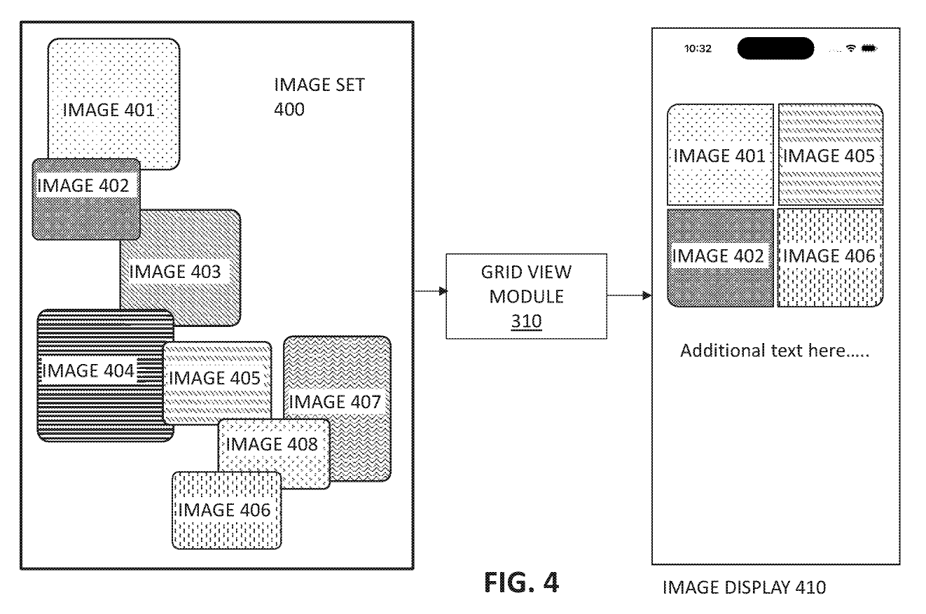

FIG. 4 depicts an example of client-based image view manipulation, in accordance with an illustrative embodiment. The example can be executed using application 222 in FIG. 2. Grid view module 310 is the same as grid view module 310 in FIG. 3.

As depicted, image set 400 includes images 401, 402, 403, 404, 405, 406, 407, and 408. Grid view module 310 generates image display 410 (a view of an application executing on a mobile device), in which images 401, 402, 405, and 406 are displayed in a 2x2 grid, with optional additional text below. For example, the optional additional text might describe an available property the images depict or explain the images. Note that the displayed grid fills the full width of image display 410.

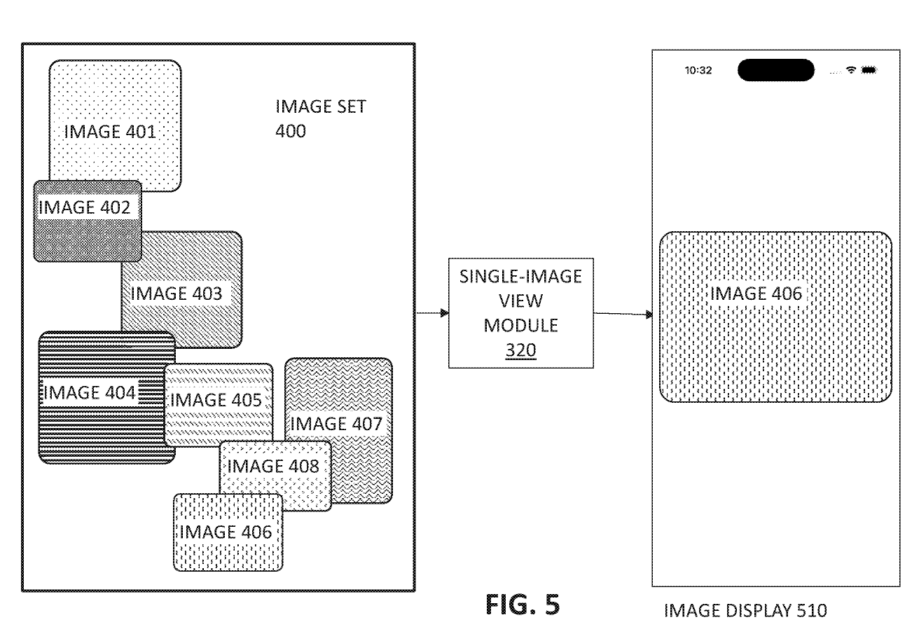

FIG. 5 depicts another example of client-based image view manipulation, in accordance with an illustrative embodiment. Single-image view module 320 is the same as single-image view module 320 in FIG. 3. Image set 400 and images 401, 402, 403, 404, 405, 406, 407, and 408 are the same as image set 400 and images 401, 402, 403, 404, 405, 406, 407, and 408 in FIG. 4.

Single-image view module 320 generates image display 510, a single-image view of image 406 in image set 400. Image 406 is displayed in the image’s original shape and aspect ratio. Note that image 406 has been masked to fit the full width of an application window in which the image is displayed.

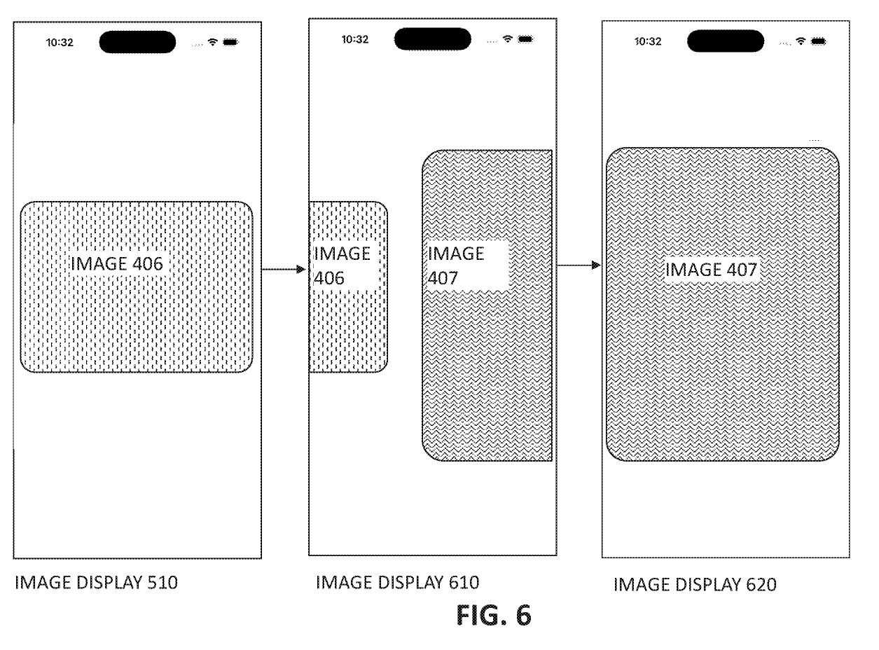

FIG. 6 depicts another example of client-based image view manipulation, in accordance with an illustrative embodiment. Images 406 and 407 are the same as images 406 and in FIG. 4. Image display 510 is the same as image display 510 in FIG. 5.

In particular, FIG. 6 depicts a transition from a single-image view of image 406 (depicted in image display 510) through a transitional display (depicted in image display 610) to a single-image view of image 407 (depicted in image display 620).

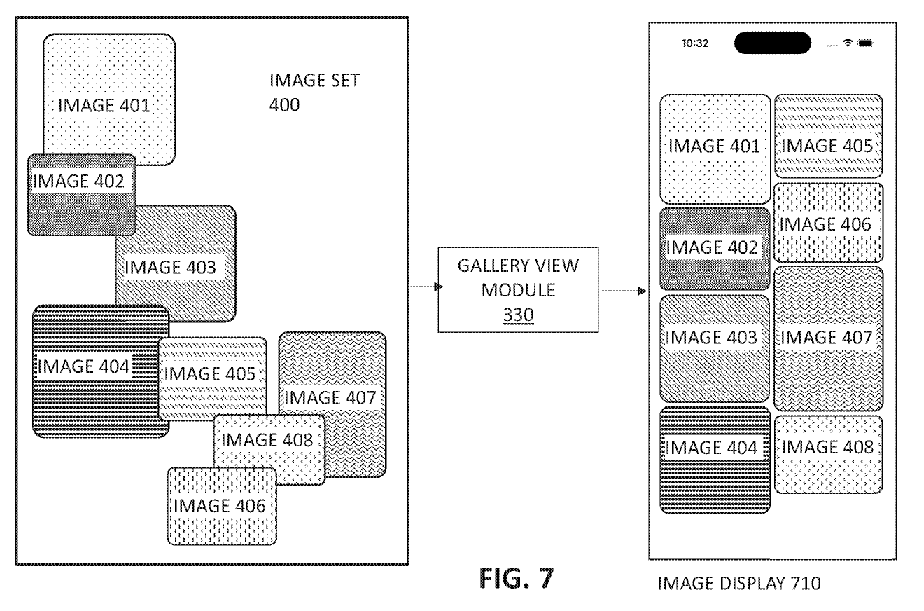

FIG. 7 depicts another example of client-based image view manipulation, in accordance with an illustrative embodiment. Gallery view module 330 is the same as gallery view module 330 in FIG. 3. Image set 400 and images 401, 402, 403, 404, 405, 406, 407, and 408 are the same as image set 400 and images 401, 402, 403, 404, 405, 406, 407, and 408 in FIG. 4.

Gallery view module 330 generates image display 710, a gallery view of images 401, 402, 403, 404, 405, 406, 407, and 408 in image set 400. Here, the gallery view displays images in one or more columns, with each image in a column having the same width but can have a different height to preserve the image’s original aspect ratio. In image display 710, the two-column image arrangement is sized to fit the full width of an application window in which the images are displayed. Note that the bottom of the leftmost column in image display 710 is slightly longer than the rightmost column, producing a pleasing arrangement for a user of a left-to-right reading language such as English.

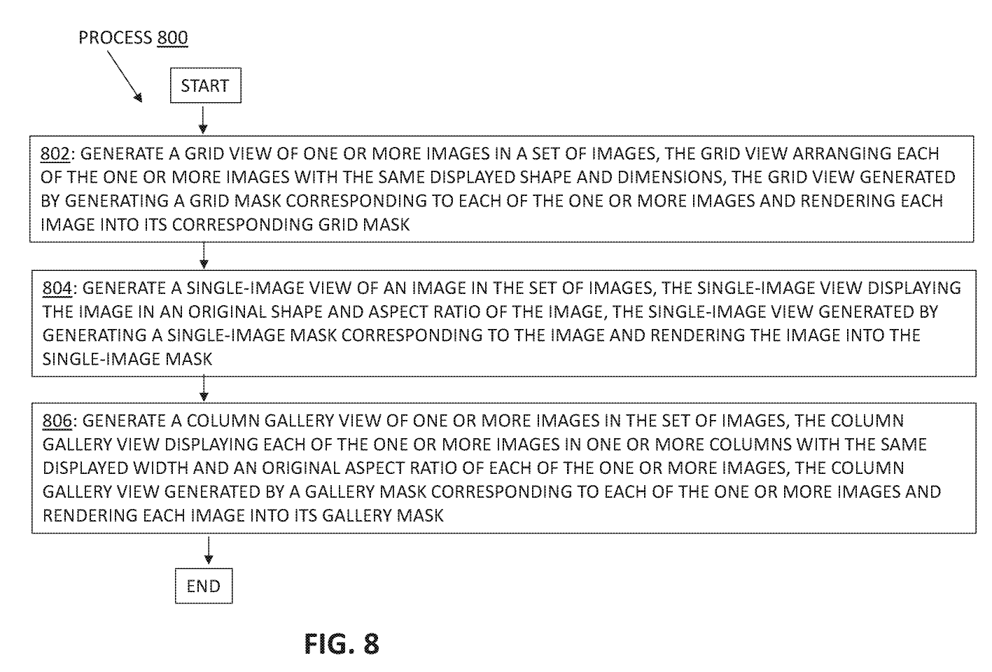

FIG. 8 depicts a flowchart of an example process for client-based image view manipulation. in accordance with an illustrative embodiment. Process 800 can be implemented in application 222 in FIG. 2.

At block 802, the process generates a grid view of one or more images in a set of images, the grid view arranging each of the one or more images with the same displayed shape and dimensions, the grid view generated by generating a grid mask corresponding to each of the one or more images and rendering each image into its corresponding grid mask. At block 804, the process generates a single-image view of an image in the set of images, the single-image view displaying the image in an original shape and aspect ratio of the image, the single-image view generated by generating a single-image mask corresponding to the image and rendering the image into the single-image mask. At block 806, the process generates a column gallery view of one or more images in the set of images, the column gallery view displaying each of the one or more images in one or more columns with the same displayed width and an original aspect ratio of each of the one or more images, the column gallery view generated by a gallery mask corresponding to each of the one or more images and rendering each image into its gallery mask. Then the process ends.

Many of the above-described features and applications may be implemented as software processes that are specified as a set of instructions recorded on a computer-readable storage medium (alternatively referred to as computer-readable media, machine-readable media, or machine-readable storage media). When these instructions are executed by one or more processing unit(s) (e.g., one or more processors, cores of processors, or other processing units), they cause the processing unit(s) to perform the actions indicated in the instructions. Examples of computer-readable media include, but are not limited to, RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, ultra-density optical discs, any other optical or magnetic media, and floppy disks. In one or more embodiments, the computer-readable media does not include carrier waves and electronic signals passing wirelessly or over wired connections, or any other ephemeral signals. For example, the computer-readable media may be entirely restricted to tangible, physical objects that store information in a form that is readable by a computer. In one or more embodiments, the computer-readable media is non-transitory computer-readable media, computer-readable storage media, or non-transitory computer-readable storage media.

In one or more embodiments, a computer program product (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

While the above discussion primarily refers to microprocessor or multi-core processors that execute software, one or more embodiments are performed by one or more integrated circuits, such as application specific integrated circuits (ASICs) or field programmable gate arrays (FPGAs). In one or more embodiments, such integrated circuits execute instructions that are stored on the circuit itself.

While this specification contains many specifics, these should not be construed as limitations on the scope of what may be claimed, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon implementation preferences, it is understood that the specific order or hierarchy of blocks in the processes may be rearranged, or that not all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The subject technology is illustrated, for example, according to various aspects described above. The present disclosure is provided to enable any person skilled in the art to practice the various aspects described herein. The disclosure provides various examples of the subject technology, and the subject technology is not limited to these examples. Various modifications to these aspects will be readily apparent to those skilled in the art, and the generic principles defined herein may be applied to other aspects.

A reference to an element in the singular is not intended to mean “one and only one” unless specifically stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the disclosure.

To the extent that the terms “include,” “have,” or the like is used in the description or the claims or clauses, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments. In one aspect, various alternative configurations and operations described herein may be considered to be at least equivalent.

As used herein, the phrase “at least one of” preceding a series of items, with the terms “and” or “or” to separate any of the items, modifies the list as a whole, rather than each member of the list (i.e., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an embodiment may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a configuration may refer to one or more configurations and vice versa.

In one aspect, unless otherwise stated, all measurements, values, ratings, positions, magnitudes, sizes, and other specifications that are set forth in this specification, including in the claims or clauses that follow, are approximate, not exact. In one aspect, they are intended to have a reasonable range that is consistent with the functions to which they relate and with what is customary in the art to which they pertain. It is understood that some or all steps, operations, or processes may be performed automatically, without the intervention of a user.

Method claims or clauses may be provided to present elements of the various steps, operations, or processes in a sample order, and are not meant to be limited to the specific order or hierarchy presented.

In one aspect, a method may be an operation, an instruction, or a function and vice versa. In one aspect, a claim may be amended to include some or all of the words (e.g., instructions, operations, functions, or components) recited in other one or more claims, one or more words, one or more sentences, one or more phrases, one or more paragraphs, and/or one or more claims.

All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description. No claim element is to be construed under the provisions of 35 U.S.C. §112, sixth paragraph, unless the element is expressly recited using the phrase “means for” or, in the case of a method claim, the element is recited using the phrase “step for.”

The Title, Background, and Brief Description of the Drawings of the disclosure are hereby incorporated into the disclosure and are provided as illustrative examples of the disclosure, not as restrictive descriptions. It is submitted with the understanding that they will not be used to limit the scope or meaning of the claims. In addition, in the Detailed Description, it can be seen that the description provides illustrative examples, and the various features are grouped together in various embodiments for the purpose of streamlining the disclosure. This method of disclosure is not to be interpreted as reflecting an intention that the included subject matter requires more features than are expressly recited in any claim. Rather, as the claims reflect, inventive subject matter lies in less than all features of a single disclosed configuration or operation. The claims are hereby incorporated into the Detailed Description, with each claim standing on its own to represent separately patentable subject matter.

Embodiments consistent with the present disclosure may be combined with any combination of features or aspects of embodiments described herein.

1. A computer-implemented method comprising:
generating a grid view of one or more images in a set of images, the grid view arranging each of the one or more images with the same displayed shape and dimensions, the grid view generated by generating a grid mask corresponding to each of the one or more images and rendering each image into its corresponding grid mask;
generating a single-image view of an image in the set of images, the single-image view displaying the image in an original shape and aspect ratio of the image, the single-image view generated by generating a single-image mask corresponding to the image and rendering the image into the single-image mask; and
generating a column gallery view of one or more images in the set of images, the column gallery view displaying each of the one or more images in one or more columns with the same displayed width and an original aspect ratio of each of the one or more images, the column gallery view generated by a gallery mask corresponding to each of the one or more images and rendering each image into its corresponding gallery mask.

2. The computer-implemented method of claim 1, wherein a portion of a first image displayed in the grid view outside a grid mask corresponding to the first image is not visible in the grid view displaying the first image.

3. The computer-implemented method of claim 1, wherein the grid mask corresponding to each of the one or more images is generated based on the dimensions of an application window in which the grid view is displayed.

4. The computer-implemented method of claim 3, wherein each grid mask has dimensions sized such that the grid view fills a width of the application window in which the grid view is displayed.

5. The computer-implemented method of claim 4, wherein the grid view comprises a two by two grid of rectangular images.

6. The computer-implemented method of claim 1, wherein a portion of a second image displayed in the single-image view outside a single-image mask corresponding to the second image is not visible in the single-image view displaying the second image.

7. The computer-implemented method of claim 1, wherein the single-image mask corresponding to the second image is generated based on the dimensions of an application window in which the single-image view is displayed.

8. The computer-implemented method of claim 7, wherein the single-image mask has dimensions sized such that the single-image view fills a width of the application window in which the single-image view is displayed.

9. The computer-implemented method of claim 1, wherein a portion of a third image displayed in the column gallery view outside a gallery mask corresponding to the third image is not visible in the column gallery view displaying the third image.

10. The computer-implemented method of claim 1, wherein the gallery mask corresponding to each of the one or more images is generated based on the dimensions of an application window in which the column gallery view is displayed.

11. The computer-implemented method of claim 10, wherein each gallery mask has dimensions sized such that the column gallery view fills a width of the application window in which the column gallery view is displayed.

12. The computer-implemented method of claim 11, wherein the column gallery view comprises two columns of rectangular images.

13. The computer-implemented method of claim 1, further comprising:
transitioning from the grid view to the single-image view via one or more transitional views, the one or more transitional views generating using masking.

14. The computer-implemented method of claim 1, further comprising:
transitioning from a first single-image view of a fourth image in the set of images to a second single-image view of a fifth image in the set of images via one or more transitional views, the one or more transitional views generating using masking implementing parallax scrolling.

15. The computer-implemented method of claim 1, further comprising:
transitioning from the single-image view to the column gallery view via one or more transitional views, the one or more transitional views generating using masking.

16. A non-transitory computer-readable medium storing a program, which when executed by a computer, configures the computer to:
generate a grid view of one or more images in a set of images, the grid view arranging each of the one or more images with the same displayed shape and dimensions, the grid view generated by generating a grid mask corresponding to each of the one or more images and rendering each image into its corresponding grid mask;
generate a single-image view of an image in the set of images, the single-image view displaying the image in an original shape and aspect ratio of the image, the single-image view generated by generating a single-image mask corresponding to the image and rendering the image into the single-image mask; and
generate a column gallery view of one or more images in the set of images, the column gallery view displaying each of the one or more images in one or more columns with the same displayed width and an original aspect ratio of each of the one or more images, the column gallery view generated by a gallery mask corresponding to each of the one or more images and rendering each image into its corresponding gallery mask.

17. The non-transitory computer-readable medium of claim 16, wherein a portion of a first image displayed in the grid view outside a grid mask corresponding to the first image is not visible in the grid view displaying the first image.

18. The non-transitory computer-readable medium of claim 16, wherein the grid mask corresponding to each of the one or more images is generated based on the dimensions of an application window in which the grid view is displayed.

19. The non-transitory computer-readable medium of claim 18, wherein each grid mask has dimensions sized such that the grid view fills a width of the application window in which the grid view is displayed.

20. A system comprising:
a processor; and
a non-transitory computer readable medium storing a set of instructions, which when executed by the processor, configure the system to:
generate a grid view of one or more images in a set of images, the grid view arranging each of the one or more images with the same displayed shape and dimensions, the grid view generated by generating a grid mask corresponding to each of the one or more images and rendering each image into its corresponding grid mask;
generate a single-image view of an image in the set of images, the single-image view displaying the image in an original shape and aspect ratio of the image, the single-image view generated by generating a single-image mask corresponding to the image and rendering the image into the single-image mask; and
generate a column gallery view of one or more images in the set of images, the column gallery view displaying each of the one or more images in one or more columns with the same displayed width and an original aspect ratio of each of the one or more images, the column gallery view generated by a gallery mask corresponding to each of the one or more images and rendering each image into its corresponding gallery mask.
